(19) United States
(12) Patent Application Publication
(10) Pub. No.: US 2016/0271645 A1
(43) Pub. Date: Sep. 22, 2016

(54) FIXING PRESSURE ROLLER AND FIXING DEVICE

(71) Applicant: SYNZTEC CO., LTD., Tokyo (JP)

(72) Inventors: Akira NISHIDA, Kanagawa (JP); Shingo SUGIYAMA, Kanagawa (JP); Masaya SUZUKI, Kanagawa (JP)

(21) Appl. No.: 15/165,173

(22) Filed: May 26, 2016

Related U.S. Application Data
(63) Continuation of application No. 14/527,823, filed on Oct. 30, 2014.

(30) Foreign Application Priority Data
Nov. 6, 2013 (JP) 2013-230675

(51) Int. Cl. B05D 3/00; G03G 15/20

(52) U.S. Cl. CPC B05D 3/007; G03G 15/2089

(57) ABSTRACT

To provide a fixing pressure roller having low roller hardness, low heat capacity, and low thermal expansion coefficient, and a fixing device including the fixing pressure roller. The fixing pressure roller of the invention for employment in a fixing unit of a fixing device has a core, and an elastic layer provided around the core, wherein the elastic layer is formed of a silicone rubber product formed by mixing a raw silicone rubber with resin microballoons and water, to thereby prepare a dispersion, and then curing the raw silicone rubber; and the silicone rubber product includes therein first voids provided from the resin microballoons and second voids which are smaller than the first voids and which are provided by evaporation of water.

### BACKGROUND OF THE INVENTION

1. Field of the Invention

The present invention relates to a pressure-applying fixing roller (hereinafter referred to as a “fixing pressure roller”) having an elastic layer, and to a fixing device having the fixing pressure roller, which fixing device is suitable for use in an image-forming apparatus.

2. Background Art

An image-forming apparatus such as a copying machine, a facsimile machine, or a laser beam printer has a fixing unit for fixing an unfixed toner image, and the fixing unit employs a fixing roller or the like. An example of such a fixing roller or the like has a metallic core, an elastic layer made of, for example, silicone rubber, and a release layer made of, for example, a fluororesin.

Generally, the elastic layer of the fixing roller or the like is made of foamed silicone rubber. Foamed silicone rubber has low hardness and such a low heat capacity that the heat of a heat source built in a fixing belt or a similar member and facing the elastic layer is not readily transferred thereto. However, such foamed rubber has a drawback. That is, cells provided by the gas generated by a foaming agent are not uniform in size and shape, resulting in poor durability of the formed rubber.

In order to overcome the drawback, there has been proposed a technique in which resin microballoons are incorporated into silicone rubber, and cells are provided from resin microballoons (see, for example, Patent Document 1). There has also been proposed another technique in which resin microballoons and ethylene glycol or a similar substance are incorporated into silicone rubber, whereby pore ways are formed between cells through breakage of resin microballoons or vaporization of ethylene glycol or the like, thereby providing foams cells communicating with one another (see, for example, Patent Document 2).

However, although the technique employing provision of cells by use of resin microballoons can reduce heat capacity by virtue of resin microballoons, the degree of foam communication is small, thereby failing to attain sufficiently low hardness, which is problematic. Also, the technique which provides pore ways between cells by means of resin microballoons and ethylene glycol causes variation in dispersion of pore ways, readily causing variation in hardness along the roller axial direction, which is also problematic. Furthermore, in an image-fixation device, the gas in the cells of silicone rubber expands through heating, thereby undesirably resulting in variation in roller diameter or the like. In this case, difficulty is encountered in controlling fixation speed. In order to solve these problems, the hardness of a silicone rubber roller must be reduced over the roller along the axial direction, and thermal expansion during heating must be suppressed.

Patent Document 1: Japanese Patent Application Laid-Open (kokai) No. 2007-065424

### Patent Document 2: Japanese Patent No. 3969942

### SUMMARY OF THE INVENTION

In view of the foregoing, an object of the present invention is to provide a fixing pressure roller having low roller hardness, low heat capacity, and low thermal expansion coefficient. Another object of the present invention is to provide a fixing device including the fixing pressure roller.

In a first mode of the present invention for attaining the aforementioned objects, there is provided a fixing pressure roller for employment in a fixing unit of a fixing device, the fixing pressure roller comprising a core, and an elastic layer provided around the core, wherein the elastic layer is formed of a silicone rubber product formed by mixing a raw silicone rubber (i.e., uncured silicone rubber or a silicone rubber raw material of silicone rubber cured product) with resin microballoons and water, to thereby prepare a dispersion, and then curing the raw silicone rubber; and the silicone rubber product includes therein first voids provided from the resin microballoons and second voids which are smaller than the first voids and which are provided by evaporation of water.

According to the first mode of the invention, the first voids provided from resin microballoons partially come into contact with the second smaller voids provided via evaporation of water, in the elastic layer, whereby voids communicating with one another are provided over the elastic layer along the axial direction. That is, a cell communication state can be attained. As a result, the elastic layer gains high porosity, and the roller hardness (i.e., the hardness of the elastic layer measured when the layer is formed on the roller) can be reduced over the layer along the axial direction of the roller. Regarding the cell communication state of the elastic layer, an excellent communication state can be attained from voids having two different dimensions. Thus, removal of air from the elastic layer is facilitated, to thereby reduce thermal expansion coefficient thereof. Furthermore, the heat capacity of the elastic layer can be reduced through incorporation of resin microballoons thereinto.

The amount of the resin microballoons incorporated into 100 parts by mass of the raw silicone rubber is preferably 1 part by mass to 5 parts by mass.

In the above state, voids provided from the resin microballoons are reliably dispersed in the elastic layer. As a result, roller hardness and thermal expansion coefficient can be further reduced.

The amount of water incorporated into 100 parts by mass of the raw silicone rubber is preferably 15 parts by mass to 60 parts by mass.

In the above state, the second smaller voids provided by evaporation of water and the first voids provided from resin microballoons are reliably dispersed in the elastic layer, whereby communication between voids is enhanced. As a result, roller hardness and thermal expansion coefficient can be further reduced.

Preferably, the raw silicone rubber further contains a surfactant.

By virtue of the surfactant, resin microballoons and water are uniformly mixed in the raw silicone rubber, to thereby provide a uniform dispersion. When the raw silicone rubber is cured, the first voids provided from resin microballoons and the second, smaller voids provided by evaporation of water are uniformly dispersed in the cured product of the silicone rubber, whereby communication between voids is further enhanced. As a result, roller hardness and thermal expansion coefficient can be reliably reduced.

The elastic layer preferably has a release layer thereon.

By virtue of the release layer, toner releasability is enhanced, to thereby attain reliable toner image fixation.

In a second mode of the present invention, there is provided a fixing device having the aforementioned fixing pressure roller.

The fixing device of the present invention has a fixing pressure roller which has low roller hardness over the roller along the roller axis direction, low heat capacity, and low thermal expansion coefficient, thereby providing high reliability in fixation performance.

According to the present invention, the first voids provided from resin microballoons partially come into contact with the second smaller voids provided via evaporation of water in silicone rubber, whereby voids communicating with one another are provided over the silicone rubber layer along the roller axial direction. Thus, the fixing pressure roller and the fixing device of the invention have low roller hardness, low heat capacity, and low thermal expansion coefficient, over the roller along the roller axis direction.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1A is a transverse cross-sectional view of a pressure roller according to Embodiment 1;

FIG. 1B is a longitudinal cross-sectional view of the same pressure roller;

FIG. 2 is a cross-sectional view of a fixing device including the pressure roller according to Embodiment 1;

FIG. 3 is a cross-sectional view of a fixing device including the fixing roller and the pressure roller according to Embodiment 2;

FIG. 4 is a cross-sectional view of a fixing device including the fixing roller and the pressure roller according to Embodiment 3;

FIG. 5 is a cross-sectional view of a fixing device including the fixing roller and the pressure roller according to Embodiment 4;

FIG. 6A is a laser microscopic photoimage of the elastic layer of Example 1; and

FIG. 6B is a laser microscopic photoimage of the elastic layer of Comparative Example 1.

### DETAILED DESCRIPTION OF PREFERRED EMBODIMENTS

Embodiments of the present invention will next be described in detail.

### Embodiment 1

The fixing pressure roller of the present invention is employed for fixing an unfixed toner imager onto a recording medium by means of heat and pressure in a fixing unit of an image-forming apparatus. As described hereinbelow, the fixing pressure roller may be applied to, for example, a pressure roller or a fixing roller. In Embodiment 1, the fixing pressure roller is employed as a pressure roller.

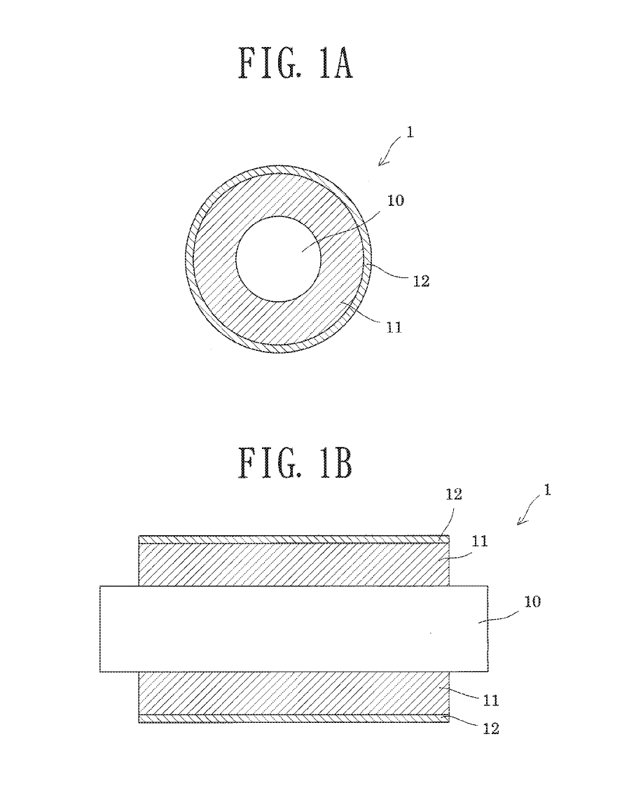

FIG. 1A is a transverse cross-sectional view of a pressure roller according to Embodiment 1, and FIG. 1B is a longitudinal cross-sectional view of the same pressure roller. The pressure roller 1 includes a core 10, an elastic layer 11 provided around the core 10, and a release layer 12 provided on the elastic layer 11.

In the present invention, the elastic layer 11 is formed of a silicone rubber product formed by mixing a raw silicone rubber with resin microballoons and water, to thereby prepare a dispersion, and then curing (heating) the raw silicone rubber. The silicone rubber product includes therein voids provided from the resin microballoons, and smaller voids provided through evaporation of water.

As used herein, the term “voids provided from resin microballoons” refers to voids provided by breakage of the resin microballoons when the raw silicone rubber is heated for curing at a temperature equal to or higher than the softening temperature of the resin microballoons. The term “breakage” refers to the case where the resin microballoons are broken, and also refers to the case where the state of the resin microballoons differs from that before heat curing of the raw silicone rubber; for example, the case where the resin microballoons crack or shrink. Meanwhile, the term “voids provided by evaporation of water” refers to small voids (foam) provided by evaporation of water when the raw silicone rubber is cured at an elevated temperature equal to or higher than the evaporation temperature of water.

In the elastic layer 11, two types of voids having different void sizes; i.e., voids provided from resin microballoons and small (fine) voids provided by evaporation of water, are maintained while they are uniformly dispersed. The voids provided from resin microballoons partially come into contact with the small voids provided via evaporation of water, whereby the voids communicating with one another are provided over the elastic layer along the roller axial direction. Under such conditions, although details will be described hereinbelow, the porosity of the elastic layer 11 can be enhanced, and the roller hardness is reduced over the elastic layer along the roller axial direction. The void-to-void communication in the elastic layer can be enhanced by virtue of the presence of voids having different dimensions, whereby air in the elastic layer can be readily removed, and thermal expansion of the rubber material can be suppressed. As a result, the thermal expansion coefficient of the elastic layer is reduced. Through incorporation of resin microballoons into the elastic layer, the heat capacity of the elastic layer can also be reduced.

The core 10 of the pressure roller 1 is formed of a metal or a resin material. No particular limitation is imposed on the metal or resin material employed, so long as it can form the core of the pressure roller 1. Also, no particular limitation is imposed on the shape of the core 10, and the core 10 may or may not be hollow.

No particular limitation is imposed on the raw silicone rubber forming the elastic layer 11, so long as the silicone rubber forms an elastic product through thermally curing the raw silicone rubber. Specific examples of the silicone rubber include liquid silicone rubber and millable silicone rubber. The silicone rubber employed may be commercially available one. Needless to say, two or more silicone rubbers may be employed in combination.

Each of the resin microballoons is formed of a thermoplastic polymer shell encapsulating a liquefied gas or a gas. Through heating, the thermoplastic polymer shells of the resin microballoons employed in Embodiment 1 are broken, to thereby provide voids in the elastic layer 11. When the resin microballoons are completely broken, a liquefied gas or a gas encapsulated by thermoplastic polymer shells are evaporated and removed, whereby the aforementioned voids are provided at the sites of broken resin microballoons. When the resin microballoons are cracked or shrunk, the resin microballoons themselves provide the aforementioned voids. Thus, the dimensions of the resin microballoons vary depending on the state of breakage. Specifically, the dimensions of voids are almost the same as the mean particle size of the resin microballoons, or slightly greater or less than the mean size. Notably, the voids may or may not include broken resin microballoons.

The resin microballoons employed in the invention may be unexpanded microballoons or expanded microballoons. The mean size of unexpanded resin microballoons falls within a range of about 6 μm to about 45 μm, and the mean size of expanded resin microballoons falls within a range of about 20 μm to about 130 μm. The size (inner diameter) of voids provided through breakage of expanded resin microballoons is preferably equal to the mean size of the expanded resin microballoons before breakage thereof. For example, when expanded resin microballoons having a mean size of 40 μm to 60 μm are employed, the size of voids provided through breakage of the microballoons is preferably 20 μm to 80 μm, more preferably 30 μm to 70 μm.

When unexpanded resin microballoons are employed, the size of voids provided through breakage of the microballoons is generally several times to several tens of times the mean size of the microballoons before breakage thereof. For example, when unexpanded resin microballoons having a mean size of 10 μm to 16 μm are employed, the size of voids provided through breakage of the microballoons is preferably 20 μm to 200 μm, more preferably 50 μm to 100 μm.

In Embodiment 1, the “mean size of resin microballoons” corresponds to the median (D50) thereof as measured by means of a laser diffraction/scattering particle size distribution meter. “Size distribution” refers to the range of sizes of voids corresponding to resin microballoons determined by measuring the size of each void on the basis of an electron micrograph thereof.

The resin microballoons employed in the invention may be commercially available ones, and two or more species thereof may be employed in combination. When liquid silicone rubber is employed as the raw silicone rubber, either unexpanded or expanded resin microballoons are preferably employed, whereas when millable silicone rubber is employed, unexpanded resin microballoons, which are less likely to break during kneading, are preferably employed.

The amount of the resin microballoons incorporated into the elastic layer may be appropriately determined in consideration of the amount of water or the below-mentioned surfactant incorporated into raw silicone rubber. Generally, the amount of the resin microballoons is preferably 0.5 parts by mass to 7.5 parts by mass, more preferably 1 part by mass to 5 parts by mass, on the basis of 100 parts by mass of the raw silicone rubber. When the amount of the resin microballoons falls within the above range, the microballoons can be uniformly and reliably dispersed in the elastic layer 11. In contrast, when the amount of the resin microballoons is excessively small, difficulty is encountered in sufficiently reducing the roller hardness, whereas when the amount of the resin microballoons is excessively large, the viscosity of the raw silicone rubber increases, which may result in failure of molding.

Water added to the raw silicone rubber is evaporated by heat in the elastic layer 11 and provides voids smaller than voids provided from resin microballoons. Such small voids partially come into contact with the voids provided from resin microballoons, whereby voids communicating with one another are provided over the silicone rubber layer along the roller axial direction. As a result, porosity is imparted to the elastic layer 11. Therefore, preferably, small voids provided through evaporation of water are uniformly dispersed in the elastic layer 11.

No particular limitation is imposed on the water employed in the invention, so long as it can be mixed with the raw silicone rubber. The water employed in the invention may be, for example, purified water, distilled water, ion-exchanged water, or tap water. No particular limitation is imposed on the temperature at mixing of water and raw silicone rubber, and heated water may be mixed with the raw silicone rubber. The amount of water incorporated may be appropriately determined in consideration of the amount of resin microballoons or the below-mentioned surfactant incorporated into raw silicone rubber. Generally, the amount of water is preferably 5 parts by mass to 100 parts by mass on the basis of 100 parts by mass of raw silicone rubber, more preferably 15 parts by mass to 60 parts by mass. Such an amount of water ensures that water and resin microballoons can be uniformly and reliably dispersed in the elastic layer 11.

In the elastic layer 11, voids having different sizes; i.e., voids provided from resin microballoons and voids provided by evaporation of water, realize a communication state. Thus, void-to-void communication is enhanced.

In order to further enhance void-to-void communication, a surfactant is preferably added in advance to the raw silicone rubber. Through incorporation of a surfactant, resin microballoons and water are uniformly mixed and dispersed in the raw silicone rubber. When the raw silicone rubber in the uniform dispersion state is cured, voids produced from resin microballoons and voids provided by evaporation of water are uniformly dispersed over the elastic layer 11. As a result, void-to-void communication is further enhanced, whereby the roller hardness and the thermal expansion coefficient of the elastic layer 11 are reliably reduced.

Examples of the surfactant includes an anionic surfactant, a cationic surfactant, an ampholytic surfactant, and a nonionic surfactant. Examples of the anionic surfactant include anionic surfactants having a hydrophilic group of a sulfonate salt type, a sulfate ester salt type, a carboxylate salt type, or a phosphate salt type. Examples of the cationic surfactant include cationic surfactants having a hydrophilic group of an ammonium salt type, a quaternary ammonium salt type, or a pyridinium salt type. Examples of the ampholytic surfactant include ampholytic surfactants having a hydrophilic group of an amino acid salt type or a betaine type. Examples of the nonionic surfactant include nonionic surfactants having, as a hydrophilic moiety, polyoxyethylene ether, glycoside, glyceryl ether, or polyether. Examples of the hydrophobic group of the above surfactants include an alkyl chain, an alkyl chain including an unsaturated bond, an alkyl chain including a benzene ring, a fluorocarbon chain, or silicone. In the present invention, no particular limitation is imposed on the type of the surfactant, and the aforementioned surfactants may be used singly or in combination of two or more species. In Embodiment 1, a nonionic surfactant is preferably used, from the viewpoint of ease of mixing/dispersion of resin microballoons and water in the raw silicone rubber. Among nonionic surfactants, a polyether-modified silicone is preferably used. Generally, the amount of surfactant is preferably 1 part by mass to 10 parts by mass, based on 100 parts by mass of raw silicone rubber.

The thickness of the elastic layer 11 is adjusted to, for example, 0.5 mm to 20 mm, preferably 2 mm to 6 mm. Adjustment of the thickness to fall within this range is for the purpose of improving toner fixability, and attaining a high-quality image.

The release layer 12 is preferably formed of a synthetic resin material having high releasability; for example, a fluororesin. Examples of the fluororesin include perfluoroalkoxy fluororesin (PFA), polytetrafluoroethylene (PTFE), tetrafluoroethylene-hexafluoropropylene copolymer (FEP), and tetrafluoroethylene-ethylene copolymer (ETFE). Particularly, perfluoroalkoxy fluororesin (PFA) is preferably employed. No particular limitation is imposed on the thickness of the release layer 12, so long as high releasability can be imparted to the fixing pressure roller. The thickness of the release layer 12 is, for example, 1 μm to 100 μm, preferably 30 μm to 70 μm. The release layer 12 may be omitted. When the release layer 12 is omitted, the fixing pressure roller is preferably employed as, for example, a fixing roller 30A of a fixing belt 20 shown below in Embodiment 3 (see FIG. 4).

Next will be described a method for producing the pressure roller of Embodiment 1.

Embodiment 1 is directed to a method for producing a pressure roller 1 in which liquid silicone rubber is employed as raw silicone rubber. Firstly, resin microballoons and water are mixed with and dispersed in liquid silicone rubber, to thereby prepare a silicone rubber composition. In Embodiment 1, a surfactant is additionally incorporated into the composition, for facilitating mixing/dispersion of resin microballoons and water in liquid silicone rubber.

Subsequently, a core 10 is placed into a mold, and the silicone rubber composition is charged around the core 10, followed by heating to cure the silicone rubber composition. Specifically, the raw silicone rubber is cured at a temperature equal to or lower than the evaporation temperature of water. Then, the silicone rubber is heated at a temperature equal to or higher than the softening temperature of resin microballoons, which are equivalent to thermoplastic polymer shells, and at a temperature equal to or higher than the evaporation temperature of water, to thereby break the resin microballoons in the silicone rubber composition and evaporate water present in the silicone rubber composition. In this case, the resin microballoons are completely broken or remain cracked or shrunk. Through the above process, voids provided through breakage of resin microballoons and voids provided by evaporation of water are distributed in the entirety of the elastic layer 11.

Notably, the curing temperature of the raw silicone rubber contained in the silicone rubber composition, the softening temperature of the resin microballoons contained in the composition, and the evaporation temperature of water are different from one another. Thus, heating may be performed stepwise corresponding to respective reaction steps (i.e., in the order of curing, softening, and evaporation). Alternatively, heating may be performed in such a manner that at least two reactions occur simultaneously. Thus, no particular limitation is imposed on the method and frequency of heating.

Subsequently, a release layer 12 is formed on the elastic layer 11. The release layer 12 may be formed of a PFA tube, or may be formed through, for example, application of a coating liquid. In an alternative manner, the raw silicone rubber is cured through heating, and then the release layer 12 is formed from the cured product. Subsequently, the layer is heated at a temperature equal to or higher than the evaporation temperature of water, or at the softening temperature of resin microballoons or higher.

The thus-produced pressure roller 1 is endowed with low roller hardness, low heat capacity, and low thermal expansion coefficient, over the roller along the axial direction. This feature is realized for the following reason. In the elastic layer 11 of the pressure roller 1, voids provided through breakage of resin microballoons partially come into contact with smaller voids provided by evaporation of water, whereby voids communicating with one another are provided over the elastic layer 11. As a result, air is readily removed from the elastic layer. Such a favorable communication state can be effectively attained through incorporation of a surfactant into the raw silicone rubber.

Alternatively, the pressure roller 1 may be produced from a millable silicone rubber. In the alternative method, resin microballoons, water, and a surfactant are added to a millable silicone rubber, to thereby prepare a silicone rubber composition. Subsequently, in one technique, the silicone rubber composition is extruded, and a core is inserted into the extruded product. The thus-obtained body is heated to cure the rubber, to thereby form a release layer made of, for example, a PFA tube around the elastic layer.

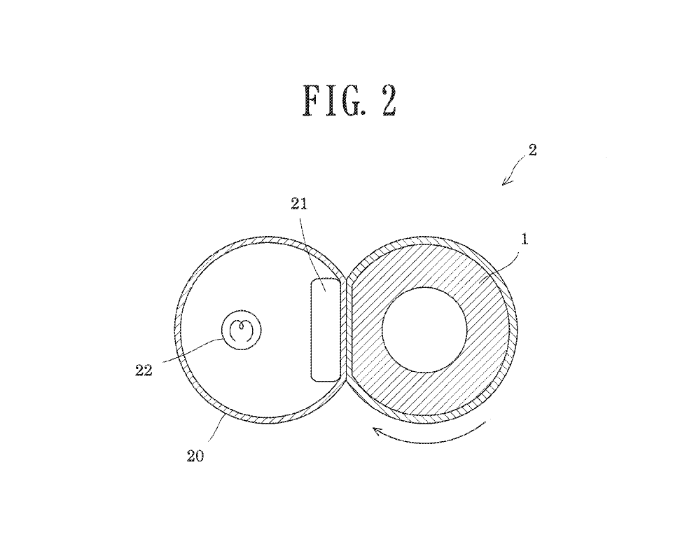

Next will be described a fixing device. FIG. 2 is a cross-sectional view of a fixing device according to Embodiment 1. As shown in FIG. 2, the fixing device 2 includes the pressure roller 1 according to Embodiment 1; a fixing belt 20 provided so as to face the pressure roller 1; a pressure member 21 which is located so as to face the pressure roller 1 and which applies pressure from the inside of the fixing belt 20 to the pressure roller 1, to thereby form a specific nip; and heating means 22 for heating the fixing belt 20 to a specific temperature.

No particular limitation is imposed on the fixing belt 20, so long as it can form a specific nip when it comes into pressure contact with the facing pressure roller 1. For example, the fixing belt 20 includes a metal substrate having at least one seamless electroformed belt; a sliding layer formed on the inner peripheral surface of the metal substrate; an elastic layer formed on the outer peripheral surface of the metal substrate; and a release layer formed on the outer peripheral surface of the elastic layer.

The pressure member 21 is formed of, for example, an elastic material (e.g., rubber), a resin, or a metal. The surface of the pressure member 21 may optionally be provided with a layer formed of a fluororesin or the like, or provided with, for example, a sliding sheet or a groove. The surface of the sliding sheet may be subjected to an embossing process.

No particular limitation is imposed on the heating means 22, so long as it can heat the fixing belt 20. The heating means 22 may be provided on the outside of the fixing belt 20. The heating means 22 may be, for example, a halogen heater, a heating wire heater, an infrared heater, or electromagnetic induction heating by means of an exciting coil (heat source). The heating means 22 may be provided inside of the pressure member 21.

The fixing device 2 of Embodiment 1 has the pressure roller 1 having low roller hardness, low heat capacity, and low thermal expansion coefficient, over the roller along the axial direction. Therefore, the fixing unit has a sufficiently wide fixing area, to thereby enhance toner fixability. Furthermore, even when the pressure roller 1 is heated, undesired variation in roller diameter due to thermal expansion or other phenomena do not occur, whereby fixing speed can be readily controlled. As a result, the fixing device exhibits excellent toner fixation performance with high reliability.

### Embodiment 2

In Embodiment 2, the fixing pressure roller is employed as a fixing roller or a pressure roller. The members of the fixing device of Embodiment 2 which are the same as those of Embodiment 1 are denoted by the same reference numerals, and repeated descriptions thereof are omitted.

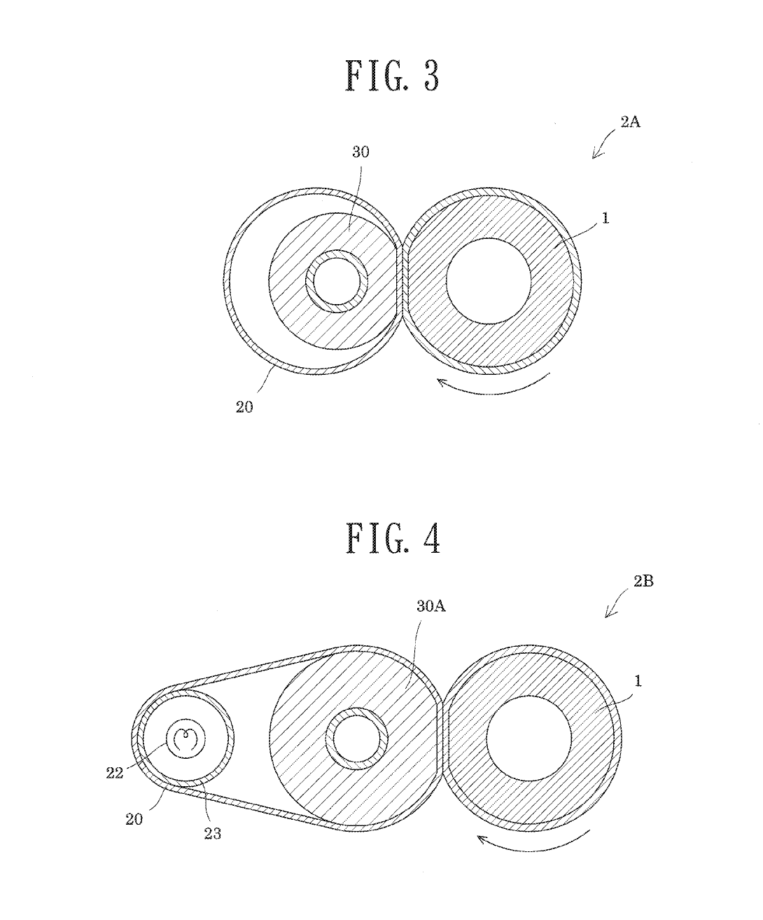

FIG. 3 is a cross-sectional view of the fixing device which includes a fixing roller and a pressure roller according to Embodiment 2. As shown in FIG. 3, the fixing device 2A includes the pressure roller 1; a fixing belt 20 provided so as to face the pressure roller 1; and a fixing roller 30 which is provided instead of a pressure member, and which applies pressure from the inside of the fixing belt 20 to the pressure roller 1. Non-illustrated heating means is provided outside of the fixing roller 30. The fixing pressure roller of the present invention 2 may serve as the fixing roller 30 or as the pressure roller 1, shown in FIG. 3.

### Embodiment 3

In Embodiment 3, the fixing pressure roller is employed as a fixing roller or a pressure roller. The members of the fixing device of Embodiment 3 which are the same as those of Embodiment 1 are denoted by the same reference numerals, and repeated descriptions thereof are omitted.

FIG. 4 is a cross-sectional view of the fixing device which includes a fixing roller and a pressure roller according to Embodiment 3. As shown in FIG. 4, the fixing device 2B includes the pressure roller 1; a fixing belt 20 provided so as to face the pressure roller 1; a fixing roller 30A which applies pressure from the inside of the fixing belt 20 to the pressure roller 1; and a heating roller 23 including therein heating means 22. The fixing roller 30A and the heating roller 23 are provided inside of the fixing belt 20, and the fixing belt 20 is rotated by means of the fixing roller 30A and the heating roller 23. The fixing pressure roller of the present invention may be employed serve as the fixing roller 30A or as the pressure roller 1, shown in FIG. 4.

### Embodiment 4

In Embodiment 4, the fixing pressure roller is employed as a fixing roller or a pressure roller. The members of the fixing device of Embodiment 4 which are the same as those of Embodiment 1 are denoted by the same reference numerals, and repeated descriptions thereof are omitted.

FIG. 5 is a cross-sectional view of the fixing device which includes a fixing roller and a pressure roller according to Embodiment 4. As shown in FIG. 5, the fixing device 2C includes the pressure roller 1, and a fixing roller 30B provided so as to face the pressure roller 1. The fixing roller 30B includes therein non-illustrated heating means. The fixing pressure roller of the present invention may serve as the fixing roller 30B or as the pressure roller 1, shown in FIG. 5.

### EXAMPLES

The present invention will next be described in detail by way of examples, which should not be construed as limiting the invention thereto.

### Example 1

A pressure roller 1 was produced through the following procedure. Specifically, liquid silicone rubber (DY39-796, product of Dow Corning Toray Co., Ltd.) (100 parts by mass) was mixed with resin microballoons (F-65DE, product of Matsumoto Yushi-Seiyaku Co., Ltd., expanded microballoons, mean size: 40 to 60 μm) (3 parts by mass) on which purified water (15 parts by mass) had been deposited, and polyether-modified silicone surfactant (ES-5612, product of Dow Corning Toray Co., Ltd.) (5 parts by mass). The resultant mixture was agitated by means of a Hobart mixer for 10 minutes, to thereby prepare a silicone rubber composition.

Subsequently, a primer (product of Dow Corning Toray Co., Ltd.) was applied onto an iron-made core (diameter: 18 mm), and the primer was dried. The primer-applied core was placed on a lower flange, and an upper flange was placed on and fixed to the lower flange. Next, the above-prepared silicone rubber composition was charged into a mold through the lower flange by means of an injection machine. The composition was heated in a thermostatic chamber at 90° C. for 90 minutes, to thereby produce an elastic layer 11. Then, the elastic layer was cooled and removed from the mold. Then, an adhesive was applied onto the elastic layer 11, and the layer was covered with a PFA tube serving as a release layer 12. The tube-covered product was heated at 210° C. for 8 hours in a thermostatic chamber, to thereby produce a pressure roller 1 (outer diameter: 030 mm) having the core 10, the elastic layer 11, and the release layer 12 formed of the PFA tube.

In parallel with production of the pressure roller 1, test pieces each formed of the elastic layer 11 were produced. In a specific procedure, the above-prepared silicone rubber composition was poured into a test piece mold having a thickness of 6 mm, and heated by means of a heating plate at 90° C. for 90 minutes. The thus-formed test piece was removed from the mold and further heated at 210° C. for 8 hours in a thermostatic chamber, to thereby yield a secondary cured test piece.

### Example 2

In Example 2, the procedure of Example 1 was repeated, except that resin microballoons (3 parts by mass) on which purified water (30 parts by mass) had been deposited were added to liquid silicone rubber, to thereby produce a pressure roller 1. Also, test pieces formed of the elastic layer 11 were produced in the same procedure as employed in Example 1.

### Example 3

In Example 3, the procedure of Example 2 was repeated, except that the surfactant (2 parts by mass) was added to liquid silicone rubber, to thereby produce a pressure roller 1. Also, test pieces formed of the elastic layer 11 were produced in the same procedure as employed in Example 1.

### Example 4

In Example 4, the procedure of Example 2 was repeated, except that no surfactant was added to liquid silicone rubber, to thereby produce a pressure roller 1. Also, test pieces formed of the elastic layer 11 were produced in the same procedure as employed in Example 1.

### Example 5

In Example 5, the procedure of Example 2 was repeated, except that resin microballoons (3 parts by mass) on which purified water (45 parts by mass) had been deposited were added to liquid silicone rubber, to thereby produce a pressure roller 1. Also, test pieces formed of the elastic layer 11 were produced in the same procedure as employed in Example 1.

### Example 6

In Example 6, the procedure of Example 1 was repeated, except that resin microballoons (1 part by mass) on which purified water (60 parts by mass) had been deposited were added to liquid silicone rubber, to thereby produce a pressure roller 1. Also, test pieces formed of the elastic layer 11 were produced in the same procedure as employed in Example 1.

### Example 7

In Example 7, the procedure of Example 2 was repeated, except that resin microballoons (5 parts by mass) on which purified water (30 parts by mass) had been deposited were added to liquid silicone rubber, to thereby produce a pressure roller 1. Also, test pieces formed of the elastic layer 11 were produced in the same procedure as employed in Example 1.

### Example 8

In Example 8, the procedure of Example 7 was repeated, except that resin microballoons (3 parts by mass) on which purified water (60 parts by mass) had been deposited were added to liquid silicone rubber, to thereby produce a pressure roller 1. Also, test pieces formed of the elastic layer 11 were produced in the same procedure as employed in Example 1.

### Comparative Example 1

In Comparative Example 1, the procedure of Example 1 was repeated, except that no purified water or surfactant was added to liquid silicone rubber, to thereby produce a pressure roller 1. Also, test pieces formed of the elastic layer 11 were produced in the same procedure as employed in Example 1.

### Test Example 1

Each of the test pieces produced in Examples 1 to 8 and Comparative Example 1 (hereinafter referred to as “elastic bodies”) was analyzed in terms of percent void communication (%) and thermal expansion coefficient (%). Moldability was determined through by checking the presence of cracking of an elastic body formed after curing (vulcanizing) of a liquid silicone rubber. Table 1 shows the components of silicone rubber composition, percent void communication, thermal expansion coefficient, and moldability of each of the test pieces of Examples 1 to 8 and Comparative Example 1. Notably, moldability (i.e., whether or not molding was complete) was evaluated with ratings O, in the case where molding was complete, and Δ, in the case where molding was complete with slightly high rubber viscosity.

Percent void communication was calculated by the following calculation formula 1. Specifically, an elastic body was placed in water and then maintained under reduced pressure for 5 minutes. When the pressure was returned to ambient pressure, the amount of water absorbed by the elastic body was measured. In calculation, a value of 1 g/cm³ was employed for the density of water.

[(Weight of elastic body after water absorption−weight of elastic body before water absorption)/[(1−(density of elastic body/density of cured silicone rubber composition))×(weight of elastic body before water absorption/density of elastic body)]]×100 [F1]

Thermal expansion coefficient was determined by the following formula 2. Specifically, an elastic body was heated from 25° C. to 200° C. in a thermostatic chamber, and the change in thickness thereof was measured.

[(Thickness of elastic body after heating−thickness of elastic body before heating)/(thickness of elastic body before heating)]×100 [F2]

The elastic body of Example 4 produced from a silicone rubber composition containing resin microballoons and purified water (hereinafter referred to simply as “water”) and containing no surfactant was compared with the elastic body of Comparative Example 1 produced from a silicone rubber composition containing only resin microballoons. The elastic body of Example 4 exhibited a percent void communication about 10 times that of the elastic body of Comparative Example 1, and a thermal expansion coefficient lower than that of the elastic body of Comparative Example 1. Thus, incorporation of resin microballoons and water into liquid silicone rubber was found to enhance percent void communication (i.e., reduce hardness) and reduce thermal expansion coefficient.

The elastic bodies of Examples 2 and 3 produced from a silicone rubber composition containing resin microballoons, water, and a surfactant were compared with the elastic body of Example 4 produced from a silicone rubber composition containing resin microballoons and water and containing no surfactant. The elastic bodies of Examples 2 and 3 exhibited a percent void communication about 2 to 3 times that of the elastic body of Example 4, and a thermal expansion coefficient lower than that of the elastic body of Example 4. Thus, incorporation of resin microballoons, water, and a surfactant into liquid silicone rubber was found to further reduce hardness and thermal expansion coefficient.

The reason for further reduction in hardness and thermal expansion coefficient is that incorporation of a surfactant into liquid silicone rubber has resulted in establishment of a favorable communication state established between voids provided from resin microballoons and voids provided by evaporation of water. Notably, such a communication state was confirmed through observation under a laser microscope performed in the below-described Test Example 2.

The elastic bodies of Examples 1 to 3, and 5 to 8 produced from a silicone rubber composition containing resin microballoons, water, and a surfactant each exhibited higher percent void communication and lower thermal expansion coefficient, as compared with the elastic body of Comparative Example 1 produced from a silicone rubber composition containing only resin microballoons. Thus, incorporation of resin microballoons, water, and a surfactant into liquid silicone rubber was also found to further reduce hardness and thermal expansion coefficient.

Regarding moldability, the silicone rubber compositions of Examples 1 to 8 and Comparative Example 1 were found to be moldable (with rating “O”) or fairly moldable with slightly high rubber viscosity (rating “Δ”). Thus, no particular problem was involved in molding the silicone rubber compositions for producing the corresponding elastic bodies.

TABLE 1

| | Silicone rubber composition components (parts by mass) | | | | Percent void | Thermal | |
|---|---|---|---|---|---|---|---|
| | Liq. silicone | Resin micro- | | | communication | expansion | |
| | rubber | balloons | Purified water | Surfactant | (%) | coeff. (%) | Moldability |
| Ex. 1 | 100 | 3 | 15 | 5 | 59.2 | 3.04 | ◯ |
| Ex. 2 | 100 | 3 | 30 | 5 | 63.2 | 2.46 | ◯ |
| Ex. 3 | 100 | 3 | 30 | 2 | 41.3 | 3.11 | ◯ |
| Ex. 4 | 100 | 3 | 30 | — | 21.7 | 3.92 | ◯ |
| Ex. 5 | 100 | 3 | 45 | 5 | 76.7 | 2.31 | ◯ |
| Ex. 6 | 100 | 1 | 60 | 5 | 8.9 | 4.25 | ◯ |
| Ex. 7 | 100 | 5 | 30 | 5 | 23.6 | 2.9 | Δ |
| Ex. 8 | 100 | 5 | 60 | 5 | 31.5 | 2.39 | Δ |
| Comp. Ex. 1 | 100 | 3 | — | — | 2.3 | 5.17 | ◯ |

### Test Example 2

The elastic bodies produced through the aforementioned procedure in Example 1 and Comparative Example 1 were observed under a laser microscope (model VK-100, product of Keyence Corporation).

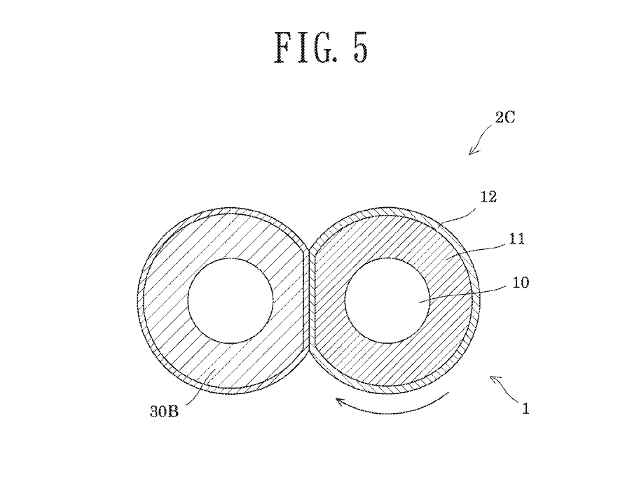

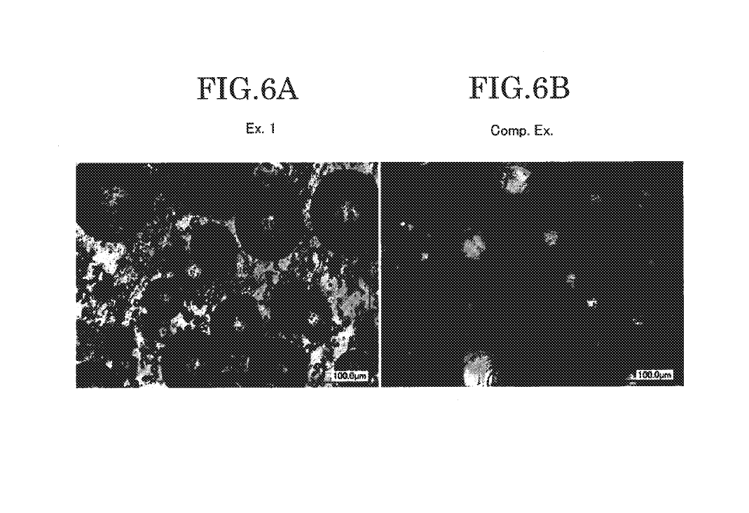

FIG. 6A is a laser microscopic image (×1,000) of an elastic body of Example 1, and FIG. 6B is a laser microscopic image (×1,000) of an elastic body of Comparative Example 1.

As shown in FIG. 6A, in the elastic body of Example 1, resin microballoons having a size of about 20 μm to about 100 μm were distributed over the elastic body. In addition to the resin microballoons, a large number of fine (small) voids having a size of about 2 μm to about 10 μm attributed to evaporation of water are distributed over the elastic body. The voids provided from the resin microballoons were found to be partially in contact with the small voids provided via evaporation of water, whereby voids communicating with one another are provided.

As shown in FIG. 6B, in the elastic body of Comparative Example 1, resin microballoons having a size of about 20 μm to about 100 μm were distributed over the elastic body. However, since the elastic body of Comparative Example 1 is produced from a silicone rubber composition containing no water, small voids as observed in Example 1 were not present.

Therefore, through incorporation of resin microballoons and water with a surfactant into liquid silicone rubber, voids formed from resin microballoons and voids formed by evaporation of water were found to be uniformly distributed over the elastic body, to thereby attain a void communication state. In addition, further incorporation of a surfactant was found to more effectively realize such a favorable void communication state.

What is claimed is:

1. A method for producing a fixing pressure roller for employment in a fixing unit of a fixing device, the fixing pressure roller having a core, and an elastic layer provided around the core,
the method comprising forming the elastic layer through first and second steps, wherein
the first step includes mixing a raw silicone rubber with resin microballoons, water, and a surfactant, to thereby prepare a dispersion, and then curing the raw silicone rubber at a temperature equal to or lower than the evaporation temperature of water; and
the second step, followings the first step, includes heating the cured product at a temperature equal to or higher than the softening temperature of shells of the resin microballoons, and at a temperature equal to or higher than the evaporation temperature of water, to thereby yield the silicone rubber product which includes therein first voids provided from the resin microballoons, and second voids provided by evaporation of water, which voids are smaller than the first voids; wherein the first voids provided from the resin microballoons partially come into contact with the small second voids provided by evaporation of water, to thereby provide voids communicating with one another over the elastic layer along the roller axial direction.

2. A fixing pressure roller production method according to claim 1, wherein the amount of the resin microballoons incorporated into 100 parts by mass of the raw silicone rubber is 1 part by mass to 5 parts by mass.

3. A fixing pressure roller production method according to claim 1, wherein the amount of water incorporated into 100 parts by mass of the raw silicone rubber is 15 parts by mass to 60 parts by mass.

4. A fixing pressure roller production method according to claim 2, wherein the amount of water incorporated into 100 parts by mass of the raw silicone rubber is 15 parts by mass to 60 parts by mass.

5. A fixing pressure roller production method according to claim 1, which method further includes a step of forming a release layer on the elastic layer.
